(19) United States
(12) Patent Application Publication
(10) Pub. No.: US 2008/0290601 A1
(43) Pub. Date: Nov. 27, 2008

(54) Asymetrical K-Ring

(75) Inventor: Martin Gottlob Rust, Beilstein (DE)

Correspondence Address: THE OLLILA LAW GROUP LLC, 2060 BROADWAY, SUITE 300, BOULDER, CO, 80302, US

(73) Assignee: Norgen, Inc., Littleton, CO (US)

(21) Appl. No.: 12/158,021

(22) PCT Filed: Jan. 5, 2006
(86) PCT No.: PCT/US2006/000385

§ 371 Date: Jun. 18, 2008

(51) Int. Cl. F16J 15/32; F16J 15/16; B23P 25/00

(52) U.S. Cl. 277/309; 277/399; 29/527.1

(57) ABSTRACT

A system and method for an asymmetric K-ring is disclosed. The system and method is for forming a K-ring with the dynamic sealing surface (514) closer to one edge or face (506) of the k-ring than the other edge or face (504) . The asymmetrically placed dynamic sealing surface creates a larger bevel (510) on one side of the K-ring thereby reducing the sealing force produced by the K-ring when pressure is applied to the side of the K-ring with the larger bevel

### BACKGROUND OF THE INVENTION

1. Field of the Invention

The invention is related to the field of sealing rings, and in particular, to an asymmetric K-ring.

2. Description of the Prior Art

Sealing rings come in many varieties. One of the best known sealing rings is the O-ring. Another type of sealing ring is the K-ring. The K-ring was originally developed by the Knorr-Bremsen Company (also known as the Knorr-Breaks Company). The original K-ring is used in the drives for pneumatic brakes. K-rings have two variations, the first type moves with the piston (see FIG. 1a) and the second type is captured by the cylinder (see FIG. 1b). FIG. 2 is a cross sectional view of K-ring 200 of the first type. K-rings typically have 2 sealing rims 202, a left face 204, a right face 206, a cavity 208 formed in the inner diameter of the K-ring, a left bevel 210, a right bevel 212, and a dynamic sealing surface 214. The left and right bevels 210 and 212 make and angle α with respect to the left and right faces 204 and 206. Angle α is approximately 50 degrees. Dynamic sealing surface 214 forms a radius of approximately 0.2 mm. Other angles and other radii may be used. Current K-rings are symmetrical about centerline AA. K-rings are typically fabricated from a flexible material, for example rubber or silicone.

FIG. 3 is a sectional view showing the general principals for how a K-ring works. The K-ring in FIG. 3 is a K-ring of the first type (i.e. the K-ring moves with the piston). FIG. 3 comprises piston 302 with sealing ring groove 304, cylinder wall 306, and K-ring 308 installed into the sealing ring groove 304. As pneumatic or hydraulic pressure is applied to the right side of the piston, as represented by arrow 310, the K-ring is forced against the left side of the sealing ring groove. The pressure, as represented by arrow 312, also penetrates under the sealing rim and fills the cavity formed in the inner diameter of the K-ring. This pressure (312) creates a force 314 that pushes the K-ring against the cylinder wall 306. The pressure applied to the right side of the K-ring (310) also interacts with the bevel 316 in the outer diameter of the K-ring, creating a force 318 that pushes the K-ring away from the cylinder wall, counteracting force 314. Because the area of the cavity formed in the inner diameter of the K-ring is larger than the area of bevel 316, force 314 is larger than force 318. The difference between force 314 and 318 is the sealing force, due to the pressure, applied by the K-ring against the cylinder wall. Even with force 318 counteracting force 314, the sealing force may still be too large and create unwanted friction between the piston and the cylinder wall.

Another problem with the current K-rings is the distribution of the sealing force across the dynamic sealing surface. FIG. 4 is a diagram of the sealing force between the cylindrical surface and the dynamic sealing surface. FIG. 4 shows K-ring 402 being forced against cylinder wall 406. Curve 420 represents the force between the K-ring 402 and the cylinder wall 406. The pressure gradient 422 on the right side is steeper than the pressure gradient 424 on the left side. The difference in pressure gradients, the magnitude of the total pressure, and the steepness of pressure gradient 422 may cause the K-ring to strip the lubricating film from the cylinder wall 406. This may increase the ware and reduce the life of the K-ring.

Therefore there is a need for an improved K-ring.

### SUMMARY OF THE INVENTION

A system and method for an asymmetric K-ring is disclosed. The system and method is for forming a K-ring with the dynamic sealing surface closer to one edge or face of the K-ring than the other edge or face. The asymmetrically placed dynamic sealing surface creates a larger bevel on one side of the K-ring thereby reducing the sealing force produced by the K-ring when pressure is applied to the side of the K-ring with the larger bevel.

### ASPECTS

One aspect of the invention includes, a K-ring having a first face and a second face opposite the first face, a first bevel formed on the first face and a second bevel formed on the second face where the first and second bevel meet at and form a dynamic sealing surface positioned between the first and second faces, characterized by:

the dynamic sealing surface placed asymmetrically between the first face and the second face whereby the first bevel is larger than the second bevel.

Preferably, the K-ring having one of the faces visibly identified as the pressure side of the K-ring.

Preferably, the K-ring having the pressure side of the K-ring corresponding to the first face.

Preferably, the K-ring having the first face on the left side of the K-ring.

Preferably, the K-ring having the first face on the right side of the K-ring.

Preferably, the K-ring having the dynamic sealing surface on an outer diameter of the K-ring.

Preferably, the K-ring having the dynamic sealing surface on an inner diameter of the K-ring.

Preferably, the K-ring having the first bevel forming an angle with the first face of approximately 40 degrees.

Preferably, the K-ring having the dynamic sealing surface forming a radius of approximately 0.6 mm.

Another aspect of the invention comprises a method for manufacturing the K-ring, characterized by:

molding the location of the dynamic sealing surface asymmetrically between the first face and the second face thereby causing the first bevel to be larger than the second bevel.

Preferably, a method for using the K-ring, characterized by:

pressurizing the first face.

Preferably, a method for using the K-ring, characterized by:

pressurizing the second face.

Another aspect of the invention comprises a K-ring, characterized by:

a means for reducing the radial pressure exerted by the K-ring when a fluid force is applied to a first side of the K-ring.

Another aspect of the invention comprises a K-ring, characterized by:

a means for increasing the radial pressure exerted by the K-ring when a fluid force is applied to a first side of the K-ring.

### BRIEF DESCRIPTION OF THE DRAWINGS

FIG. 1 is a sectional view of two types of K-rings (Prior art).

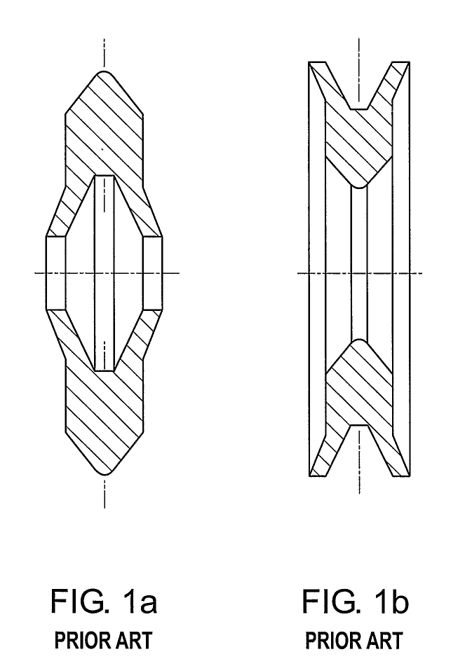

FIG. 2 is a sectional view of a K-ring showing the different parts of a K-ring (Prior art).

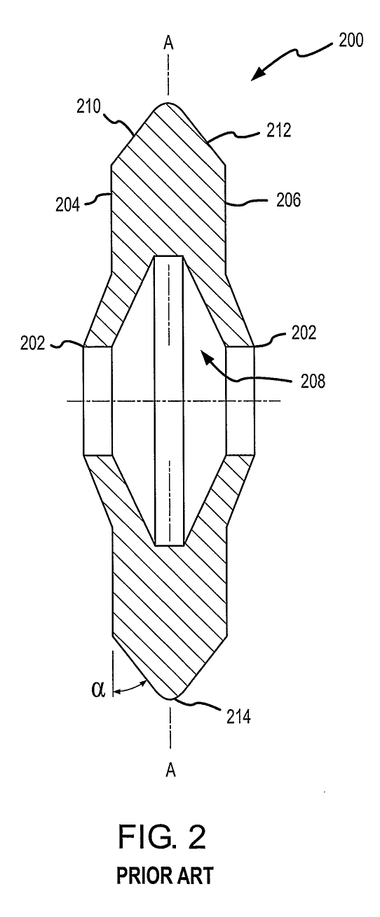

FIG. 3 is a sectional view showing the general principals on how a K-ring works (Prior art).

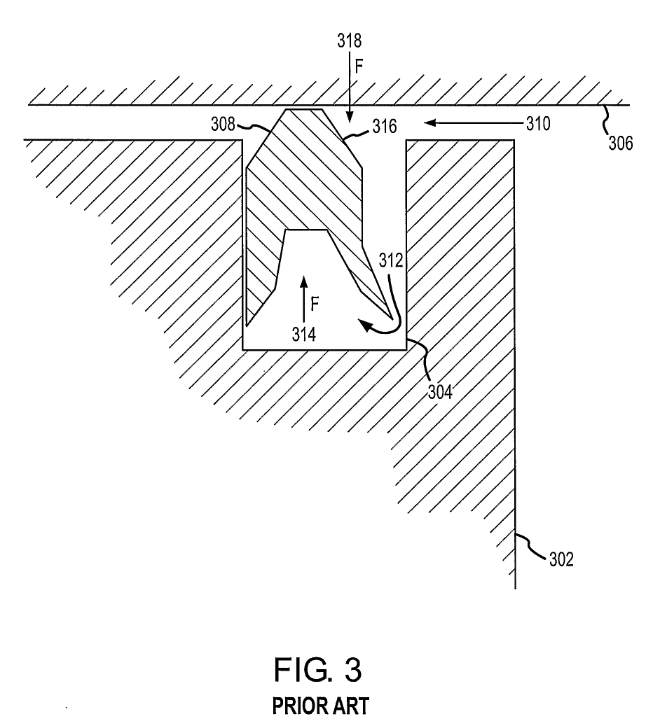

FIG. 4 is a diagram of the sealing force between the cylindrical surface and the dynamic sealing surface (Prior art).

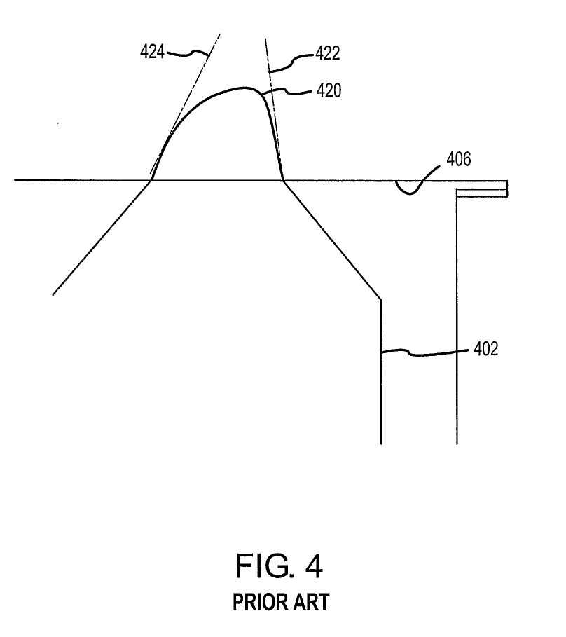

FIG. 5 is a cross sectional view of asymmetric K-ring 500 in one example embodiment of the invention.

### DETAILED DESCRIPTION OF THE PREFERRED EMBODIMENT

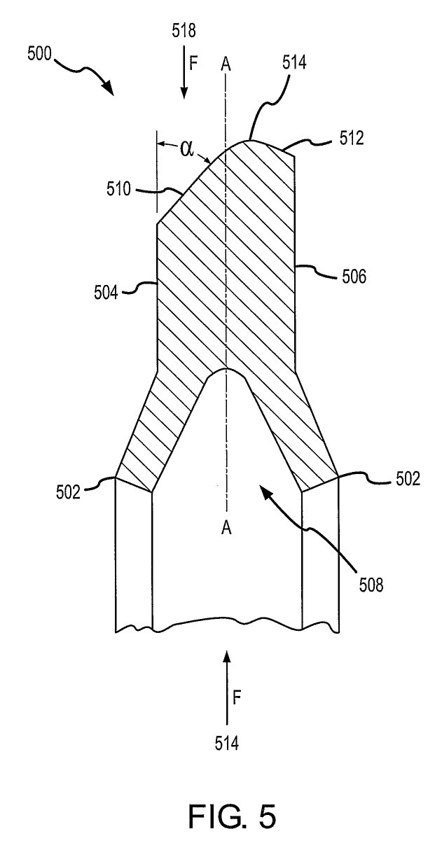

FIGS. 5 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 5 is a cross sectional view of asymmetric K-ring 500 in an example embodiment of the invention. K-ring 500 has two sealing rims 502, a left face 504, a right face 506, a cavity 508 formed in the inner diameter of the K-ring, a left bevel 510, a right bevel 512, and a dynamic sealing surface 514. Bevel 510 forms an angle of approximately 40 degrees with left face 504. Dynamic sealing surface 514 forms a radius of approximately 0.6 mm.

Dynamic sealing surface 514 is no longer symmetrically placed about centerline AA but is closer to the right face 506 of the K-ring than the left face 504. Moving dynamic sealing surface 514 closer to side 506 of the K-ring creates a larger bevel 510 on one side of the K-ring than bevel 512 on the other side of the K-ring. In one example embodiment of the invention, when dynamic sealing surface 514 is moved close to face 506, bevel 512 may only be formed as part of the radius forming dynamic sealing surface 514. In another example embodiment of the invention, when dynamic sealing surface 514 is only offset from centerline AA by a small amount, bevel 512 may start as part of the radius forming dynamic sealing surface 514 and then merge into a straight segment that ends at surface 506.

In operation, when pressure is applied to the left face 504 of K-ring 500, the pressure interacts with bevel 510 creating force 518. The pressure also interacts with cavity 508 creating force 514. Force 514 causes the K-ring to push against a cylinder wall (not shown) and force 518 counteracts force 514 reducing the surface pressure the K-ring applies against the cylinder wall. Because dynamic sealing surface 514 is closer to face 506, bevel 510 is larger than a corresponding bevel in a symmetric K-ring. Because bevel 510 is larger, force 518 is larger. The larger force 518 counteracts more of force 514 thereby reducing the overall pressure the K-ring applies to the cylinder wall.

When pressure is applied to the right face 506 of K-ring 500, the pressure interacts with bevel 512 creating force 518. The pressure also interacts with cavity 508 creating force 514. Force 514 causes the K-ring to push against a cylinder wall (not shown) and force 518 counteracts force 514 reducing the pressure the K-ring applies to the cylinder wall. Because dynamic sealing surface 514 is closer to face 506, bevel 512 is smaller than a corresponding bevel in a symmetric K-ring. Because bevel 512 is smaller, force 518 is smaller. The smaller force 518 counteracts less of force 514 thereby increasing the overall pressure the K-ring applies to the cylinder wall.

By moving the dynamic sealing surface towards or away from the side of the K-ring where the pressure is applied, the sealing force between the K-ring and the cylinder wall can be increased or decreased. For a K-ring designed to reduce the sealing force, there would be two different directional K-rings. One K-ring designed to be used with the pressure applied to the left face of the K-ring (as shown in FIG. 5) and one K-ring designed to be used with the pressure applied to the right face of the K-ring (Not shown). A K-ring designed to increase the sealing force would also have two different directional K-rings.

The dynamic sealing surface can be moved to different positions between the center line and one face of the K-ring, dependent on how much of a reduction in force is desired or how much of an increase in force is desired.

Because the K-ring is asymmetric, a visible identification may be added to one of the sides of the K-ring to indicate which face is the pressure face. For example, a mark or a short phrase may be molded or stamped into the side of the K-ring that is designed as the pressure side. Other types of visible identification may also be used, for example a different color may be used to indicate the pressure side.

The examples describe above use the type of K-ring that moves with the piston. The asymmetric K-ring can also be used as the type captured by the cylinder.

We claim:

1. A K-ring having a first face (504) and a second face (506) opposite the first face, a first bevel (510) formed on the first face (504) and a second bevel (512) formed on the second face (506) where the first and second bevel meet at and form a dynamic sealing surface (514) positioned between the first and second faces, characterized by:
the dynamic sealing surface (514) placed asymmetrically between the first face (504) and the second face (506) whereby the first bevel (510) is larger than the second bevel (512.)

2. The K-ring of claim 1 characterized by having one of the faces visibly identified as the pressure side of the K-ring.

3. The K-ring of claim 1 characterized by having the pressure side of the K-ring corresponding to the first face.

4. The K-ring of claim 1 characterized by having the first face (504) on the left side of the K-ring.

5. The K-ring of claim 1 characterized by having the first face (504) on the right side of the K-ring.

6. The K-ring of claim 1 characterized by having the dynamic sealing surface (514) on an outer diameter of the K-ring.

7. The K-ring of claim 1 characterized by having the dynamic sealing surface on an inner diameter of the K-ring.

8. The K-ring of claim 1 characterized by having the first bevel forming an angle with the first face of approximately 40 degrees.

9. The K-ring of claim 1 characterized by having the dynamic sealing surface forming a radius of approximately 0.6 mm.

10. A method for manufacturing the K-ring of claim 1, characterized by:
molding the location of the dynamic sealing surface asymmetrically between the first face and the second face thereby causing the first bevel to be larger than the second bevel.

11. A method for using the K-ring of claim 1, characterized by:
pressurizing the first face.

12. A method for using the K-ring of claim 1, characterized by:
pressurizing the second face.

13. A K-ring, characterized by:
a means for reducing the radial pressure exerted by the K-ring when a fluid force is applied to a first side of the K-ring.

14. A K-ring, characterized by:
a means for increasing the radial pressure exerted by the K-ring when a fluid force is applied to a first side of the K-ring.
